(19) United States
(12) Patent Application Publication
(10) Pub. No.: US 2012/0110025 A1
(43) Pub. Date: May 3, 2012

(54) CODING ORDER-INDEPENDENT COLLECTIONS OF WORDS

(75) Inventor: Yuriy Reznik, Seattle, WA (US)

(73) Assignee: QUALCOMM INCORPORATED, San Diego, CA (US)

(21) Appl. No.: 13/217,990

(22) Filed: Aug. 25, 2011

Related U.S. Application Data
(60) Provisional application No. 61/407,553, filed on Oct. 28, 2010.

(51) Int. Cl. G06F 17/30

(52) U.S. Cl. 707/797; 707/E17.012

(57) ABSTRACT

In general, techniques are described for order-independent coding of a collection of words. An apparatus comprising a compression unit and an interface may implement the techniques. The compression unit constructs a digital search tree to store two or more words. A prefix of each of the words identifies a path from a root node to the node storing the corresponding word. A suffix of each of the words is stored in the node identified by the corresponding prefix. The compression unit traverses the digital search tree data structure, retrieving each of the suffixes in accordance with a defined order and encodes the suffixes. The compression unit encodes the digital search tree data structure in a manner that encodes an arrangement but not the placement of the nodes. The interface transmits the encoded digital search structure and the encoded suffixes in the defined order.

This application claims the benefit of U.S. Provisional Application No. 61/407,553 filed Oct. 28, 2010, the entire content of which is incorporated herein by reference.

### TECHNICAL FIELD

This disclosure relates to coding systems and, more particularly, coding systems that code collections of words.

### BACKGROUND

Visual search in the context of computing devices or computers refers to techniques that enable a computer or other device to perform a search for objects and/or features among other objects and/or features within one or more images. Recent interest in visual search has resulted in algorithms that enable computers to identify partially occluded objects and/or features in a wide variety of changing image conditions, including changes in image scale, noise, illumination, and local geometric distortion. During this same time, mobile devices have emerged that feature cameras, but which may have limited user interfaces for entering text or otherwise interfacing with the mobile device. Developers of mobile devices and mobile device applications have sought to utilize the camera of the mobile device to enhance user interactions with the mobile device.

To illustrate one enhancement, a user of a mobile device may utilize a camera of the mobile device to capture an image of any given product while shopping at a store. The mobile device may then initiate a visual search algorithm within a set of archived feature descriptors for various reference images to identify the product shown in the image (which may be referred to as a “search image”) based on matching reference imagery. After identifying the product, the mobile device may then initiate a search of the Internet and present a webpage containing information about the identified product, including a lowest cost for which the product is available from nearby merchants and/or online merchants. In this manner, the user may avoid having to interface with the mobile device via a keyboard (which is often a “virtual” keyboard in the sense that it is presented on a touch screen as an image with which the user interfaces) or other input mechanism but may merely capture a search image to initiate the visual search and subsequent web searches.

While there are a number of applications that a mobile device equipped with a camera and access to visual search may employ, visual search algorithms often involve significant processing resources that generally consume significant amounts of power. Performing visual search with power-conscious devices that rely on batteries for power, such as the above noted mobile, portable and handheld devices, may be limited, especially during times when their batteries are near the end of their charges. As a result, architectures have been developed to avoid having these power-conscious devices implement visual search in its entirety. Instead, a visual search device (which is often referred to as a “visual search server”) is provided that performs the power intensive portions of the visual search separately from the power-conscious device. The power-conscious devices initiate a session with the visual search device and, in some instances, provide feature descriptors extracted from an image to the visual search device in a search request. The visual search device performs the visual search by comparing the extracted feature descriptors to an archived set of feature descriptors to identify objects and/or features of the image from which the feature descriptors were extracted by the power-conscious device. The visual search server then returns a search response specifying these objects and/or features identified by the visual search. In this way, power-conscious devices have access to visual search but avoid having to perform the processor-intensive visual search that consumes significant amounts of power.

Typically, the mobile device transmits the extracted feature descriptors to the visual search server via a network, such as the Internet. Yet, a feature descriptor extracted from one image may be multiple kilobytes (Kbs) to hundreds of kilobytes. For example, each feature descriptor extracted in accordance with a scale-invariant feature transform (SIFT) visual search algorithm is 128 bytes in size. There may be 1000 or more feature descriptors extracted for any given image for a total size on the order of 100 s of kilobytes. In order to avoid needlessly consuming bandwidth of the network and to improve the speed with which these extracted feature descriptors may be sent via the network, the power-conscious device often compresses the extracted feature descriptors using various compression algorithms. The visual search device, upon receiving these compressed feature descriptors, first decompresses these feature descriptors, then performs a search, and sends the search results back.

### SUMMARY

In general, techniques are described for coding an order-independent collection of words, such as a collection of feature descriptors extracted by a mobile device in implementing at least a portion of a visual search algorithm. Rather than employ standard compression algorithms that are optimized for an order-dependent collection of words, the mobile device may employ a compression algorithm consistent with the techniques described in this disclosure that is capable of encoding an order-independent collection of words. The phrase “order-dependent collection of words” refers to a collection of words where the place or order of one of these words relative to the other words has significance. An example of an order-dependent collection of words is a sentence, where the position of each word of the sentence relative to the order words of the sentence has significance to the reader. Traditional compression algorithms optimized to compress order-dependent collections of words are therefore optimized to preserve the order of the words with respect to one another. The compression techniques described in this disclosure, however, are optimized to compress order-independent collections of words, such as feature descriptors whose order relative to one another have no significance. By implementing the order-independent compression techniques described in this disclosure, the mobile device may more efficiently compress feature descriptors or any other order-independent set of words. As a result of more efficiently compressing these types of order-independent sets of words, the techniques may facilitate more efficient storage and transmission of these types of words.

In one aspect, a method for coding an unordered set of two or more words, the method comprises constructing a digital search tree data structure with a compression unit to store the two or more words, wherein the digital search tree includes a node to store each of the two or more words, wherein a prefix of each of the two or more words identifies a path from a root to one of the nodes that stores the corresponding one of the two or more words, and wherein a suffix of each of the words is stored in the node identified by the corresponding prefix of the two or more words. The method also comprises traversing the digital search tree data structure with the compression unit to retrieve each of the suffixes of the words of the two or more words in accordance with a defined order, encoding the suffixes with the compression unit in the defined order in which the suffixes were retrieved from the digital search tree data structure, and encoding the digital search tree data structure with the compression unit in a manner that encodes an arrangement of the nodes in the digital search tree data structure without encoding the placement of the nodes of the digital search tree data structure with respect to one another to generate an encoded digital search tree data structure. The method further comprises transmitting the encoded digital search structure with an interface and transmitting the encoded suffixes with the interface in the defined order in which the suffixes were retrieved from the digital search tree data structure.

In another aspect, an apparatus for coding two or more words in an order-independent manner, the apparatus comprises means for constructing a digital search tree data structure with a compression unit to store the two or more words, wherein the digital search tree includes a node to store each of the two or more words, wherein a prefix of each of the two or more words identifies a path from a root to one of the nodes that stores the corresponding one of the two or more words, and wherein a suffix of each of the words is stored in the node identified by the corresponding prefix of the two or more words. The apparatus also comprises means for traversing the digital search tree data structure with the compression unit to retrieve each of the suffixes of the words of the two or more words in accordance with a defined order, means for encoding the suffixes with the compression unit in the defined order in which the suffixes were retrieved from the digital search tree data structure, and means for encoding the digital search tree data structure with the compression unit in a manner that encodes an arrangement of the nodes in the digital search tree data structure without encoding the placement of the nodes of the digital search tree data structure with respect to one another to generate an encoded digital search tree data structure. The apparatus also comprises means for transmitting the encoded digital search structure and means for transmitting the encoded suffixes in the defined order in which the suffixes were retrieved from the digital search tree data structure.

In another aspect, an apparatus for coding two or more words in an order-independent manner, the apparatus comprises a compression unit that constructs a digital search tree data structure to store the two or more words, wherein the digital search tree includes a node to store each of the two or more words, wherein a prefix of each of the two or more words identifies a path from a root to one of the nodes that stores the corresponding one of the two or more words, and wherein a suffix of each of the words is stored in the node identified by the corresponding prefix of the two or more words. The compression unit further traverses the digital search tree data structure to retrieve each of the suffixes of the words of the two or more words in accordance with a defined order, encodes the suffixes in the defined order in which the suffixes were retrieved from the digital search tree data structure, encodes the digital search tree data structure in a manner that encodes an arrangement of the nodes in the digital search tree data structure without encoding the placement of the nodes of the digital search tree data structure with respect to one another to generate an encoded digital search tree data structure. The apparatus further comprises an interface that transmits the encoded digital search structure and the encoded suffixes in the defined order in which the suffixes were retrieved from the digital search tree data structure.

In another aspect, A non-transitory computer-readable medium comprising instructions for coding two or more words in an order-independent manner that, when executed, cause one or more processors to construct a digital search tree data structure with a compression unit to store the two or more words, wherein the digital search tree includes a node to store each of the two or more words, wherein a prefix of each of the two or more words identifies a path from a root to one of the nodes that stores the corresponding one of the two or more words, and wherein a suffix of each of the words is stored in the node identified by the corresponding prefix of the two or more words, traverse the digital search tree data structure with the compression unit to retrieve each of the suffixes of the words of the two or more words in accordance with a defined order, encode the suffixes with the compression unit in the defined order in which the suffixes were retrieved from the digital search tree data structure, encode the digital search tree data structure with the compression unit in a manner that encodes an arrangement of the nodes in the digital search tree data structure without encoding the placement of the nodes of the digital search tree data structure with respect to one another to generate an encoded digital search tree data structure, transmit the encoded digital search structure with an interface and transmit the encoded suffixes with the interface in the defined order in which the suffixes were retrieved from the digital search tree data structure.

In another aspect, a method for decoding two or more coded words expressed as an index and corresponding one or more coded suffixes of the two or more coded words ordered in accordance with a defined order, the method comprises converting the index into a bit sequence, constructing a digital search tree data structure based on the bit sequence, wherein the digital search tree data structure comprises a node for storing each of one or more decoded words corresponding to the coded words and traversing the digital search tree data structure in accordance with the defined order to generate prefixes for the decoded words that maintain the defined order. The method further comprises decoding the coded suffixes to generate decoded suffixes that maintain the defined order and generating one or more decoded words corresponding to the coded words based on the decoded suffixes and the output prefixes.

In another aspect, an apparatus for decoding two or more coded words expressed as an index and corresponding two or more coded suffixes of the two or more coded words ordered in accordance with a defined order, the apparatus comprises means for converting the index into a bit sequence, and means for constructing a digital search tree data structure based on the bit sequence, wherein the digital search tree data structure comprises a node for storing each of two or more decoded words corresponding to the coded words. The apparatus also comprises means for traversing the digital search tree data structure in accordance with the defined order to generate prefixes for the decoded words that maintain the defined order, means for decoding the coded suffixes to generate decoded suffixes that maintain the defined order and means for generating two or more decoded words corresponding to the coded words based on the decoded suffixes and the output prefixes.

In another aspect, an apparatus for decoding two or more coded words expressed as an index and corresponding two or more coded suffixes of the two or more coded words ordered in accordance with a defined order, the apparatus comprises a reconstruction unit that converts the index into a bit sequence, constructs a digital search tree data structure based on the bit sequence, wherein the digital search tree data structure comprises a node for storing each of two or more decoded words corresponding to the coded words, traverses the digital search tree data structure in accordance with the defined order to generate prefixes for the decoded words that maintain the defined order, decodes the coded suffixes to generate decoded suffixes that maintain the defined order and generates two or more decoded words corresponding to the coded words based on the decoded suffixes and the output prefixes.

In another aspect, a non-transitory computer-readable medium comprising instructions for decoding two or more coded words expressed as an index and corresponding two or more coded suffixes of the two or more coded words ordered in accordance with a defined order, wherein the instruction, when executed, cause two or more processors to convert the index into a bit sequence, construct a digital search tree data structure based on the bit sequence, wherein the digital search tree data structure comprises a node for storing each of two or more decoded words corresponding to the coded words, traverse the digital search tree data structure in accordance with the defined order to generate prefixes for the decoded words that maintain the defined order decode the coded suffixes to generate decoded suffixes that maintain the defined order and generate two or more decoded words corresponding to the coded words based on the decoded suffixes and the output prefixes.

The details of one or more aspects of the techniques are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram illustrating an image processing system that implements the successively refinable quantization techniques described in this disclosure.

FIG. 2 is a block diagram illustrating an example of both the feature compression unit and the feature reconstruction unit of FIG. 1 in more detail.

FIG. 3 is a flowchart illustrating example operation of a client device in implementing the order-independent coding aspects of the techniques described in this disclosure.

FIG. 4 is a flowchart illustrating exemplary operation of a visual search server device in implementing the order-independent decoding aspects of the techniques described in this disclosure.

FIG. 5 is a diagram illustrating an example DST constructed in accordance with the order independent coding techniques described in this disclosure.

FIG. 6 is a diagram illustrating pre-order tree traversal of the DST shown in the example of FIG. 5 in order to generate a bit sequence in accordance with the order-independent techniques described in this disclosure.

### DETAILED DESCRIPTION

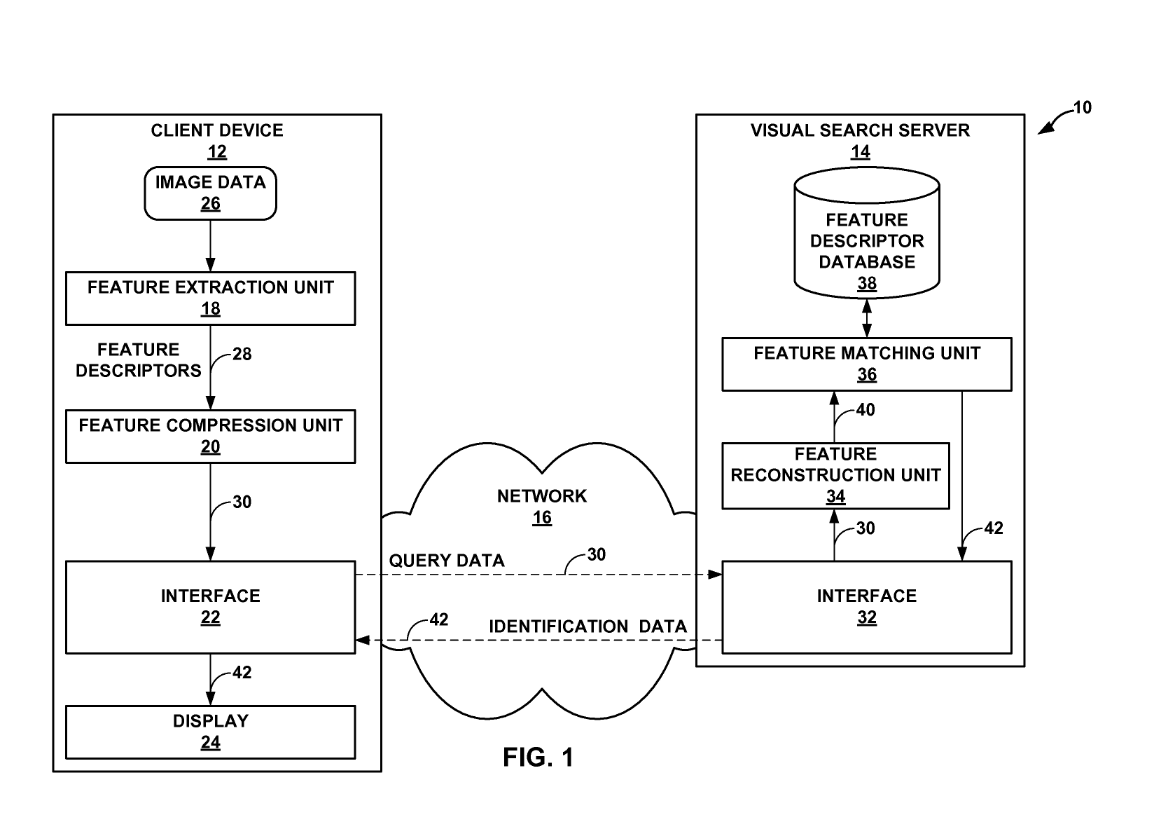

FIG. 1 is a block diagram illustrating an image processing system 10 that implements the order-independent feature coding techniques described in this disclosure. In the example of FIG. 1, image processing system 10 includes a client device 12, a visual search server 14 and a network 16. Client device 12 represents in this example a mobile device, such as a laptop, a so-called netbook, a personal digital assistant (PDA), a cellular or mobile phone or handset (including so-called “smartphones”), a global positioning system (GPS) device, a digital camera, a digital media player, a game device, or any other mobile device capable of communicating with visual search server 14. While described in this disclosure with respect to a mobile client device 12, the techniques described in this disclosure should not be limited in this respect to mobile client devices. Instead, the techniques may be implemented by any device capable of communicating with visual search server 14 via network 16 or any other communication medium.

Visual search server 14 represents a server device that accepts connections typically in the form of transmission control protocol (TCP) connections and responds with its own TCP connection to form a TCP session by which to receive query data and provide identification data. Visual search server 14 may represent a visual search server device in that visual search server 14 performs or otherwise implements a visual search algorithm to identify one or more features or objects within an image. In some instances, visual search server 14 may be located in a base station of a cellular access network that interconnects mobile client devices to a packet-switched or data network.

Network 16 represents a public network, such as the Internet, that interconnects client device 12 and visual search server 14. Commonly, network 16 implements various layers of the open system interconnection (OSI) model to facilitate transfer of communications or data between client device 12 and visual search server 14. Network 16 typically includes any number of network devices, such as switches, hubs, routers, servers, to enable the transfer of the data between client device 12 and visual search server 14. While shown as a single network, network 16 may comprise one or more sub-networks that are interconnected to form network 16. These sub-networks may comprise service provider networks, access networks, backend networks or any other type of network commonly employed in a public network to provide for the transfer of data throughout network 16. While described in this example as a public network, network 16 may comprise a private network that is not accessible generally by the public.

As shown in the example of FIG. 1, client device 12 includes a feature extraction unit 18, a feature compression unit 20, an interface 22 and a display 24. Feature extraction unit 18 represents a unit that performs feature extraction in accordance with a feature extraction algorithm, such as, for example, a compressed histogram of gradients (CHoG) algorithm, a scale-invariant feature transform (SIFT) algorithm or any other feature description extraction algorithm that extracts features. Generally, feature extraction unit 18 operates on image data 26, which may be captured locally using a camera or other image capture device (not shown in the example of FIG. 1) included within client device 12. Alternatively, client device 12 may store image data 26 without capturing this image data itself by way of downloading this image data 26 from network 16, locally via a wired connection with another computing device or via any other wired or wireless form of communication.

Feature extraction unit 18 may, in summary, extract a feature descriptor 28 by Gaussian blurring image data 26 to generate several consecutive Gaussian-blurred images. Guassian blurring generally involves convolving image data 26 with a Gaussian blur function at a defined scale. Feature extraction unit 18 may incrementally convolve image data 26, where the resulting Gaussian-blurred images are separated from each other by a constant in the scale space. Feature extraction unit 18 then stacks these Gaussian-blurred images to form what may be referred to as a “Gaussian pyramid” or a “difference of Gaussian pyramid.”Feature extraction unit 18 then compares two successively stacked Gaussian-blurred images to generate difference of Gaussian (DoG) images. The DoG images may form what is referred to as a “DoG space.”

Based on this DoG space, feature extraction unit 18 may detect keypoints, where a keypoint refers to a region or patch of pixels around a particular sample point or pixel in image data 26 that is potentially interesting from recognition perspective. Generally, feature extraction unit 18 identifies keypoints as local maxima and/or local minima in the constructed DoG space. Feature extraction unit 18 then assigns these keypoints one or more orientations, or directions, based on directions of a local image gradient for the patch in which the keypoint was detected. To characterize these orientations, feature extraction unit 18 may define the orientation in terms of a gradient orientation histogram. Feature extraction unit 18 then defines feature descriptor 28 as a location and an orientation (e.g., by way of the gradient orientation histogram). After defining feature descriptor 28, feature extraction unit 18 outputs this feature descriptor 28 to feature compression unit 20. Feature extraction unit 18 may output a set of feature descriptors 28 using this process.

Feature compression unit 20 represents a unit that compresses or otherwise reduces an amount of data used to define feature descriptors, such as feature descriptors 28, relative to the amount of data used by feature extraction unit 18 to define these feature descriptors. To compress the feature descriptor, feature compression unit 20 may implement the techniques described in this disclosure. Feature compression unit 20 may output the compressed feature descriptors 28 as query data 30. Interface 22 represents any type of interface that is capable of communicating with visual search server 14 via network 16, including wireless interfaces and wired interfaces. Interface 22 may represent a wireless cellular interface and include the necessary hardware or other components, such as antennas, modulators and the like, to communicate via a wireless cellular network with network 16 and via network 16 with visual search server 14. In this instance, although not shown in the example of FIG. 1, network 16 includes the wireless cellular access network by which wireless cellular interface 22 communicates with network 16. Display 24 represents any type of display unit capable of displaying images, such as image data 26, or any other types of data. Display 24 may, for example, represent a light emitting diode (LED) display device, an organic LED (OLED) display device, a liquid crystal display (LCD) device, a plasma display device or any other type of display device.

Visual search server 14 includes an interface 32, a feature reconstruction unit 34, a feature reconstruction unit 36 and a feature descriptor database 38. Interface 32 may be similar to interface 22 in that interface 32 may represent any type of interface capable of communicating with a network, such as network 16. Feature reconstruction unit 34 represents a unit that decompresses compressed feature descriptors to reconstruct the feature descriptors from the compressed feature descriptors. Feature reconstruction unit 34 may perform operations inverse to those performed by feature compression unit 20 in that feature reconstruction unit 34 performs the inverse of compression (often referred to as reconstruction) to reconstruct feature descriptors from the compressed feature descriptors (which is shown as “query data 30” in the example of FIG. 1). Feature reconstruction unit 34 may output reconstructed feature descriptors 40 to feature reconstruction unit 36.

Feature reconstruction unit 36 represents a unit that performs feature matching to identify one or more features or objects in image data 26 based on reconstructed feature descriptors 40. Feature reconstruction unit 36 may access feature descriptor database 38 to perform this feature identification, where feature descriptor database 38 stores data defining feature descriptors. This data also associates at least some of these feature descriptors with identification data identifying the corresponding feature or object extracted from image data 26. Upon successfully identifying the feature or object extracted from image data 26 based on reconstructed feature descriptors, such as reconstructed feature descriptor 40 (which may also be referred to herein as “query data 40” in that this data represents visual search query data used to perform a visual search or query), feature reconstruction unit 36 returns this identification data as identification data 42.

Initially, a user of client device 12 interfaces with client device 12 to initiate a visual search. The user may interface with a user interface or other type of interface presented by display 24 to select image data 26 and then initiate the visual search to identify one or more features or objects that are the focus of the image stored as image data 26. For example, image data 26 may specify an image of a piece of famous artwork. The user may have captured this image using an image capture unit (e.g., a camera) of client device 12 or, alternatively, downloaded this image from network 16 or, locally, via a wired or wireless connection with another computing device. In any event, after selecting image data 26, the user initiates the visual search to, in this example, identify the piece of famous artwork by, for example, name, artist and date of completion.

In response to initiating the visual search, client device 12 invokes feature extraction unit 18 to extract at least one feature descriptor 28 describing one of the so-called “keypoints” found through analysis of image data 26. Feature extraction unit 18 forwards this feature descriptor 28 to feature compression unit 20, which proceeds to compress feature descriptor 28 and generate query data 30A. Feature compression unit 20 outputs query data 30 to interface 22, which forwards query data 30 via network 16 to visual search server 14.

Interface 32 of visual search server 14 receives query data 30. In response to receiving query data 30, visual search server 14 invokes feature reconstruction unit 34. Feature reconstruction unit 34 attempts to reconstruct feature descriptors 28 based on query data 30 and outputs reconstructed feature descriptors 40. Feature reconstruction unit 36 receives reconstructed feature descriptors 40 and performs feature matching based on feature descriptors 40. Feature reconstruction unit 36 performs feature matching by accessing feature descriptor database 38 and traversing feature descriptors stored as data by feature descriptor database 38 to identify a substantially matching feature descriptor. Upon successfully identifying the feature extracted from image data 26 based on reconstructed feature descriptors 40, feature reconstruction unit 36 outputs identification data 42 associated with the feature descriptors stored in feature descriptor database 38 that matches to some extent (often expressed as a threshold) reconstructed feature descriptors 40. Interface 32 receives this identification data 42 and forwards identification data 42 via network 16 to client device 12.

Interface 22 of client device 12 receives this identification data 42 and presents this identification data 42 via display 24. That is, interface 22 forwards identification data 42 to display 24, which then presents or displays this identification data 42 via a user interface, such as the user interface used to initiate the visual search for image data 26. In this instance, identification data 42 may comprise a name of the piece of artwork, the name of the artist, the data of completion of the piece of artwork and any other information related to this piece of artwork, including hypertext transport protocol (HTTP) links. In some instances, interface 22 forwards identification data to a visual search application executing within client device 12, which then uses this identification data (e.g., by presenting this identification data via display 24).

While various components, modules, or units are described in this disclosure to emphasize functional aspects of devices configured to perform the disclosed techniques, these units do not necessarily require realization by different hardware units. Rather, various units may be combined in a hardware unit or provided by a collection of inter-operative hardware units, including one or more processors as described above, in conjunction with suitable software and/or firmware stored to computer-readable mediums. In this respect, reference to units in this disclosure is intended to suggest different functional units that may or may not be implemented as separate hardware units and/or hardware and software units.

In performing this form of networked visual search, client device 12 consumes power or energy, which is often limited in the mobile or portable device context in the sense that these devices employ batteries or other energy storage devices to enable portability, extracting feature descriptors 28 and then compressing these feature descriptors 28 to generate query data 30. In some instances, feature compression unit 20 may not be invoked to compress feature descriptors 28. For example, client device 12 may not invoke feature compression unit 20 upon detecting that available power or energy is below a certain threshold of available power, such as 20% of available power. Client device 12 may provide these thresholds to balance bandwidth consumption with power consumption.

Commonly, bandwidth consumption is a concern for mobile devices that interface with a wireless cellular access network because these wireless cellular access networks may provide only a limited amount of bandwidth for a fixed fee or, in some instances, charge for each kilobyte of bandwidth consumed. If compression is not enabled, such as when the above noted threshold is exceeded, client device 12 sends feature descriptors 28 as query data 30 without first compressing feature descriptors 28. While avoiding compression may conserve power, sending uncompressed feature descriptors 28 as query data 30 may increase the amount of bandwidth consumed, which in turn may increase costs associated with performing the visual search. In this sense, both power and bandwidth consumption are a concern when performing networked visual search.

Another concern associated with networked visual search is latency. Commonly, feature descriptors 28 are defined as a 128-element vector that has been derived from 16 histograms with each of these histograms having 8 bins. Compression of feature descriptors 28 may reduce latency in that communicating less data generally takes less time than communicating relatively more data.

In accordance with the techniques described in this disclosure, feature compression unit 20 of client device 12 compresses feature descriptors 30 without regard to the order in which feature descriptors 30 were generated. That is, rather than employ compression algorithms that are optimized for an order-dependent collection of words, feature compression unit 20 may employ a compression algorithm consistent with the techniques described in this disclosure that allows encoding an order-independent collection of words. The phrase “order-dependent collection of words” refers to a collection of words where the place or order of one of these words relative to the other words has significance.

An example of order-dependent collection of words is a sentence, where the position of each word of the sentence relative to the order words of the sentence has significance to the reader. Traditional compression algorithms optimized to compress order-dependent collections of words are therefore optimized to preserve the order of the words with respect to one another. The compression techniques described in this disclosure, however, are optimized to compress order-independent collections of words, such as feature descriptors whose order relative to one another have no significance. By implementing the order-independent compression techniques described in this disclosure, feature compression unit 20 may more efficiently compress feature descriptors. As a result of more efficiently compressing these types of order-independent sets of words, the techniques may facilitate more efficient storage and transmission of feature descriptors 30.

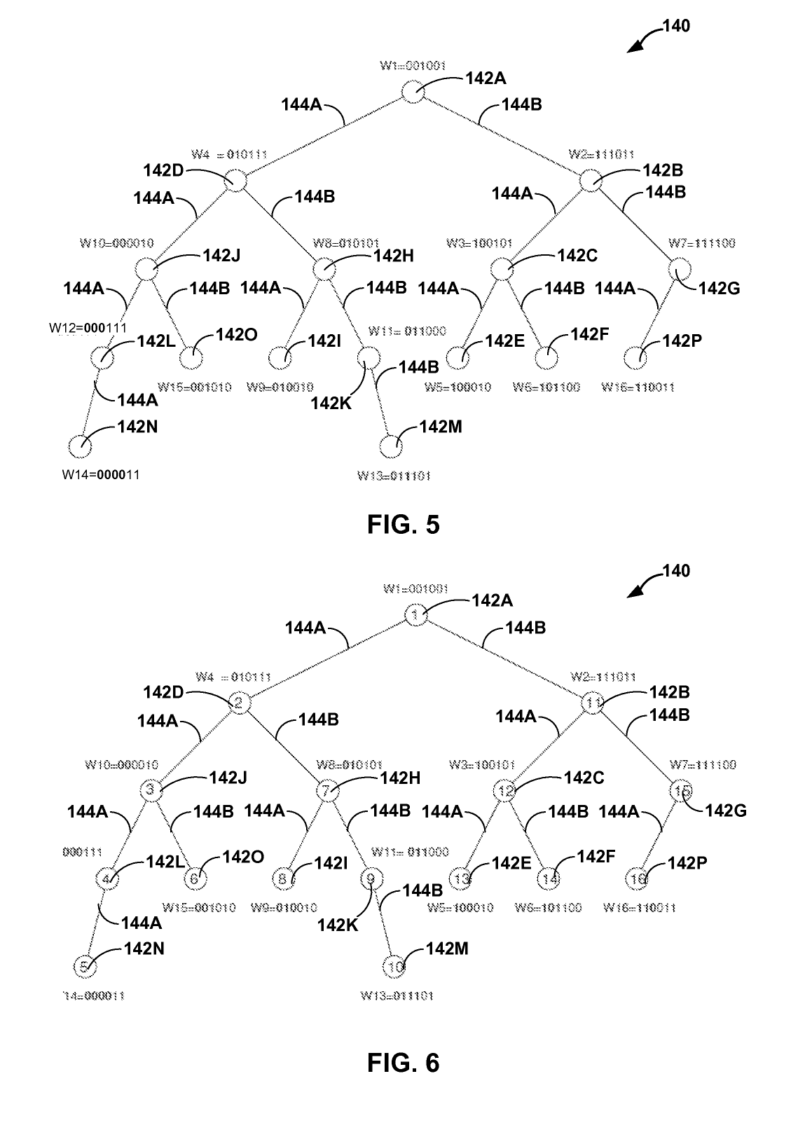

To illustrate the order-independent coding techniques, assume that feature compression unit 20 receives one or more feature descriptors 28 generated by feature extraction unit 18 according to one of the feature extraction algorithms described above (e.g., CHoG or SIFT). In order to compress feature descriptors 28, feature compression unit 20 first constructs a digital search tree (DST) data structure (which is described in more detail below with respect to the example of FIGS. 5 and 6) to store feature descriptors 28. The DST data structure includes an element (which may also be referred to as a “node” in this disclosure) to store each of feature descriptors 28. A prefix of each of feature descriptors 28 identifies path from the root to another node of the DST data structure that stores the corresponding one of feature descriptors 28. A suffix of each of feature descriptors 28 may be identified by a pointer stored in the node of the DST data structure identified by the corresponding prefix of the corresponding one of feature descriptors 28. While described with respect to a DST data structure, the techniques may employ some other suitable data structure that may facilitate compact representation of sets of words, including a trie structure, Patricia trie, Level-Compressed (LC)-trie, etc.

After constructing the DST data structure, feature compression unit 20 encodes the DST data structure in a manner that encodes an arrangement of the elements, which may also be referred to as nodes, in the DST data structure without encoding the placement of the elements of the DST data structure with respect to one another to generate an encoded DST data structure. In some instances, feature compression unit 20 implements an algorithm referred to as “Zack's ranking scheme” to compute a lexicographic index of the generated DST data structure that identifies the generated DST data structure in a set of all possible DST data structures constructed for the same number of feature descriptors as the number of feature descriptors 28 used to construct the DST data structure for feature descriptors 28.

In effect, Zack's ranking scheme defines a way by which all possible DST data structures constructed for the same number of feature descriptors as that included within feature descriptors 28 may be lexicographically ordered. Due to this set way of ordering these DST data structures, Zack's ranking scheme may then assign an index to each of these lexicographically-ordered DST data structures such that this index uniquely identifies the generated DST data structures in the lexicographical ordering of all possible DST data structure that could have been generated for the same number of feature descriptors as that included within feature descriptors 28. When implemented, Zack's ranking scheme may mathematically compute this index for the generated DST data structure without generating an ordered list of all possible DST data structures and then assigning an index to each of these DST data structures. The computed lexicographical index represents an encoding of the generated DST data structure.

In computing this lexicographic index, feature compression unit 20 may traverse each element of the DST data structure in a defined order. Following this same defined order, feature compression unit 20 may traverse the elements of the DST data structure to retrieve each of the suffixes of feature descriptors 28. Feature compression unit 20 may then encode the retrieved suffixes in the defined order in which the suffixes were retrieved from the DST data structure. Feature compression unit 20 may encode these suffixes using any suitable encoding techniques (such as Shannon, Huffman, or arithmetic coding techniques). Feature compression unit 20 may then output query data 30, which includes both the encoded DST data structure (which in this example is the lexicographic index) and the encoded suffixes in the defined order in which the suffixes were retrieved from the DST data structure. Interface 22 may transmit query data 30 via network 16 to interface 32 of visual search server 14.

Interface 32 of visual search server 14 receives this query data 30, passing query data 30 to feature reconstruction unit 34. As noted above, feature reconstruction unit 34 implements operations inverse to those implemented by feature compression unit 20. In other words, feature reconstruction unit 34 decodes the encoded DST data structure (i.e., generates the DST data structure identified by the lexicographic index). Feature reconstruction unit 34, after generating the DST data structure based on the lexicographic index included within query data 30, then scans the elements of the reconstructed DST data structure in the same order as feature compression unit 20 to retrieve the prefixes for reconstructed feature descriptors 40. Feature reconstruction unit 34 then sequentially decodes the encoded suffixes pairing the decoded suffixes with the retrieved prefixes to generate reconstructed feature descriptors 40.

Typically, about log m! bits may be saved when compressed in accordance with the order-independent coding techniques described in this disclosure. Parameter m in this formula defines the number of features in a set. As a result, feature compression unit 20 may generate query data 30 that is smaller in terms of bit size than that generated by conventional feature compression units employing an order-dependent compression algorithm. Thus, the techniques may promote more efficient storage in any context and less bandwidth consumption and reduced latency in networked (particularly wireless or cellular) or other communication environments.

While described in this disclosure with respect to a particular example, i.e., a networked visual search example (which may also be referred to as a “networked computer vision example”), the techniques may be implemented by any networked or non-networked computing device to efficiently compress and/or decompress compressed order-independent sets of words. The techniques may be implemented in any field where an unordered collection of words is a common simplifying assumption, where such fields include natural language processing, data retrieval, document classification and machine learning.

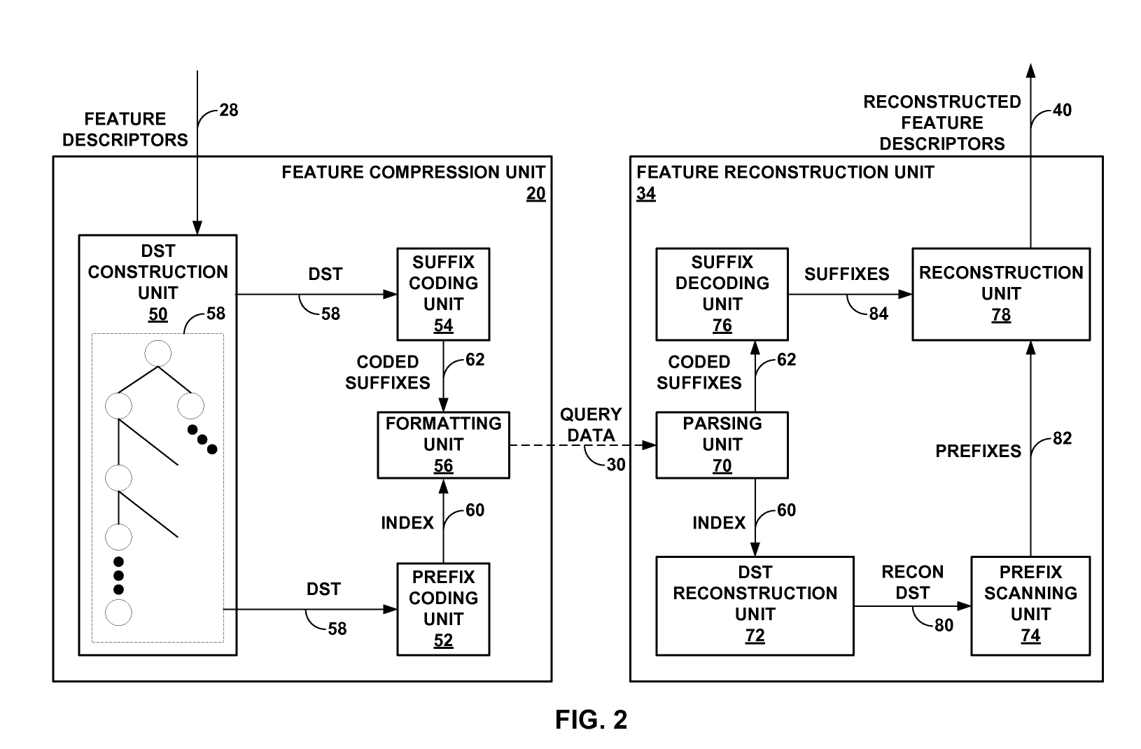

FIG. 2 is a block diagram illustrating an example of both feature compression unit 20 and feature reconstruction unit 34 of FIG. 1 in more detail. As shown in the example of FIG. 2, feature compression unit 20 includes a digital search tree (DST) construction unit 50, a prefix coding unit 52, a suffix coding unit 54 and a formatting unit 56. DST construction unit 50 represents a unit that receives feature descriptors 28 and constructs a DST data structure 58 (which may be referred to as “DST 58”) based on received feature descriptors 28.

DST 58 may represent a tree data structure organized based on the bits of stored values (i.e., feature descriptors 28 in this example). The root element of DST 58 is normally empty, merely denoting the starting place of the search. Up to two sub-trees may depend from the root element. At this first level (with the root element being at level zero), a first one of feature descriptors 28 is selected and the first bit is analyzed. If this first bit is a one, this first one of feature descriptors 28 is stored to the right sub-tree depending from the root element. If this first bit is a zero, this one of feature descriptors 28 is stored to the right sub-tree depending from the root element.

DST construction unit 50 may then select a second one of feature descriptors 28, analyzing the first bit of the second one of feature descriptors 28 to determine whether it is a one or a zero. If the first bit of the second one of feature descriptors 28 is a one, DST construction unit 50 determines that this second one of feature descriptors 28 is to be stored to the right sub-tree. If an element is already stored at level zero in either the left or right sub-trees depending from the root node, DST construction unit 50 may analyze a second bit of the second one of feature descriptors 28 to determine whether this second bit is a one or a zero. If this second bit is a one, DST construction unit 50 determines that this second one of feature descriptors 28 is to be stored to the right sub-tree depending from the root element of the sub-tree depending from the root element. If this second bit is a zero, DST construction unit 50 determines that this second one of feature descriptors 28 is to be stored to the left sub-tree depending from the root element of the sub-tree depending from the root element. This process continues until DST construction unit 50 determines that a root element of one of these sub-trees is empty, storing the second one of features descriptors 28 to this empty element. In this manner, DST construction unit 50 may construct a binary tree sorted based on the bits defining feature descriptors 28, which is referred to in this disclosure as a “digital search tree.”

DST construction unit 50 may output or otherwise pass a reference to DST 58 to prefix coding unit 52. Prefix coding unit 52 represents a unit that codes prefixes stored to DST 58, where these prefixes represent bit prefixes of each of feature descriptors 28. That is, the bits used to determine where in DST 58 each successive one of feature descriptors 28 are stored may be referred to as a prefix in that these bits represents a prefix for each of feature descriptors 28. Prefix coding unit 52 may traverse or otherwise scan DST 58 in accordance with a set scan order. This scan order may be statically set, dynamically configured or determined. If dynamically configured or determined, this scan order may be signaled to feature reconstruction unit 34 so that feature reconstruction unit 34 may be able to decode query data 30. In any event, prefix coding unit 52 may scan DST 58, generating a bit for each non-empty element of DST 58 that stores one of feature descriptors 28 during its traversal of DST 58. Prefix coding unit 52 then encodes this sequence of bits generated when traversing DST 58. Prefix coding unit 52 may encode this sequence of bits using Zack's ranking scheme, which is a lexicographic sorting algorithm that ranks this sequence of bits with respect to all other sequences of bits having the same length as the generated sequence of bits. While described with respect to Zack's ranking algorithm, the techniques may employ any other algorithm capable of compressing this bit sequence. Prefix coding unit 52 outputs this rank 60, which may also be referred to as “index 60,” to formatting unit 56.

Meanwhile, DST construction unit 50 also outputs or otherwise passes a reference to DST 58 to suffix coding unit 54. Suffix coding unit 54 represents a unit that encodes suffixes of feature descriptors 28 stored to DST 58, where the suffixes refer to any bits not used to determine where in DST 58 each of feature descriptors 28 are to be stored. For example, a given one of feature descriptors 28 may be stored in the first level of DST 58, meaning that only the first bit was used to determine its location in DST 28 and that its prefix is one bit in length. The remaining bits of this one of feature descriptors 28 represent the suffix. Suffix coding unit 54 traverses DST 58 according to the same scan order as that employed by prefix coding unit 52 when generating the bit sequence described above. Suffix coding unit 54 may employ any type of coding scheme, such as a Shannon, Huffman or arithmetic coding scheme. Suffix coding unit 54 then outputs coded suffixes 62 in the order in which they were scanned from DST 58 to formatting unit 56.

Formatting unit 56 represents a unit that formats index 60 and coded suffixes 32 in a manner so that feature reconstruction unit 34 may parse index 60 and coded suffixes 32. Formatting unit 56 may be statically configured to arrange index 60 in a predetermined way with respect to coded suffixes 32 or may dynamically determine the arrangement of index 60 and coded suffixes 32. If dynamically determined, formatting unit 56 may signal or otherwise inform feature reconstruction unit 34 of this dynamically determined arrangement. While described as only formatting index 60 and coded suffixes 62 to generate query data 30, formatting unit 56 may arrange other information with respect to index 60 and coded suffixes 62 that may facilitate performing a visual search with respect to feature descriptors 28. In any event, formatting unit 56 outputs these coded feature descriptors 30 (which is another name for index 60 and coded suffixes 32) as query data 30. In the example of FIG. 1, query data 30 is sent via network 16 to feature reconstruction unit 34 of visual search server 14, where this transmission is denoted by a dash-lined arrow labeled “query data 30.”

As further shown in the example of FIG. 2, feature reconstruction unit 34 includes a parsing unit 70, a DST reconstruction unit 72, a prefix scanning unit 74, a suffix decoding unit 76 and a reconstruction unit 78. Parsing unit 70 represents a unit that parses query data 30 to extract index 60 and coded suffixes 62. Parsing unit 70 may parse query data 30 according to a set parsing scheme or a dynamically determined parsing scheme (where the dynamically determined parsing scheme may be signaled by formatting unit 56 in query data 30). Parsing unit 70 may extract coded suffixes 62 so as to retain the order of coded suffixes 62 as sent in query data 30. Parsing unit 70 outputs index 60 to DST reconstruction unit 72 and ordered coded suffixes 62 to suffix decoding unit 76.

DST reconstruction unit 72 represents a unit that receives an index, such as index 60, and reconstructs a DST, such as DST 58, based on the received index. DST reconstruction unit 72 may perform the inverse operation as prefix coding unit 52 to generate the bit sequence from index 60. As noted above, this bit sequence identifies whether each element, when traversed in the predetermined or dynamically determined order, stores one of feature descriptors 28. DST reconstruction unit 72 then reconstructs each element of DST 58 according to this bit sequence, where typically a bit value of one indicates that a corresponding element stores one of feature descriptors 28 and a bit value of zero indicates that a corresponding element does not store one of feature descriptors 28 (or, in other words, is empty).

To illustrate, consider a binary bit sequence of 110000₂. It is assumed for this example that DST reconstruction unit 72 is configured to perform pre-order tree traversal where DST reconstruction unit 72 first visits the root, which is assumed to be empty, then traverses the left sub-tree and, after traversing the left sub-tree, traverses the right sub-tree. DST reconstruction unit 72, therefore, first creates an empty root node and then considers the first most significant bit of the binary bit sequence, which in this illustration is set to one. In response to this bit value of one, DST reconstruction unit 72 creates a left child element and links this left child element to the root element. Given that this newly created node is at level one in reconstructed DST data structure 80 (which is shown as “recon DST 80” in the example of FIG. 2) and is a left child element, the prefix for this node is assumed to be a binary bit value of 0. DST reconstruction unit 72 then analyzes the next most significant bit in the binary bit sequence shown above, which in this example is assumed to be a bit value of one.

In response to this second bit value of one, DST reconstruction unit 72 creates another left-child element and links this left-child element to the previously created left child element. Given that this newly created node is at level two in reconstructed DST data structure 80 and is a left child element, the prefix for this node is assumed to be a binary two bit value of 00. DST reconstruction unit 72 then analyzes the third most significant bit in the binary bit sequence shown above, which in this example is assumed to be a bit value of zero. A bit value of zero indicates that this second left child element does not itself have a left child element. DST reconstruction unit 72 then analyzes the fourth most significant bit, which in this example is assumed to be a binary bit value of zero. This bit value indicates that this second left child element also does not itself have a right child element. DST reconstruction unit 72 then iteratively considers the fifth and sixth most significant bits, which are both assumed to be zero in this example, where these bits indicated respectively that the first left-child node does not itself have a right child element and the root node does not itself have a right child element. In this manner, DST reconstruction unit 72 may reconstruct DST 58, outputting reconstructed DST 80 to prefix scanning unit 74.

Prefix scanning unit 74 represents a unit that implements the set or dynamically determined scanning order to extract prefixes, such as prefixes 82, from a reconstructed DST, such as reconstructed DST 80. Prefix scanning unit 74 may scan reconstructed DST according to the above described pre-order tree traversal algorithm, scanning the left sub-tree of each element until reaching a leaf element (which is another name for an element that has no child elements), then iteratively scanning the right sub-trees of each element. At each traversed element, prefix scanning unit 74 outputs one of prefixes 82 depending on the current level of the traversed element and the location of the current element in reconstructed DST 80. Prefix scanning unit 74 outputs prefixes 82 to reconstruction unit 78.

Meanwhile, suffix decoding unit 76 receives coded suffixes 62. Suffix decoding unit 76 represents a unit that decodes coded suffixes 62 in accordance with the coding scheme employed by suffix coding unit 54 to encode these suffixes (such as the above noted Huffman, Shannon and arithmetic coding schemes). Suffix decoding unit 76 outputs suffixes 84, maintaining the order in which encoded suffices 62 were specified in query data 30. Reconstruction unit 78 represents a unit that concatenates prefixes 82 with corresponding suffixes 84 to output reconstructed feature descriptors 40. Because the order of suffixes 84 is maintained and mirrors the order in which coded suffixes 62 were specified in query data 30 and this order matches the order in which prefix scanning unit 74 extracts prefixes 82 from reconstructed DST 80, reconstruction unit 78 typically concatenates each of prefixes 82 with its associated ones of suffixes 84 by iteratively concatenating a first one of prefixes 82 (where first refers to the order in which it is specified with respect to the remaining ones of prefixes 82 in this context) to a first one of suffixes 84 (where again first refers to the order in which it is specified with respect to the remaining ones of suffixes 84 in this context). This process may continue until every one of reconstructed feature descriptors 40 is generated.

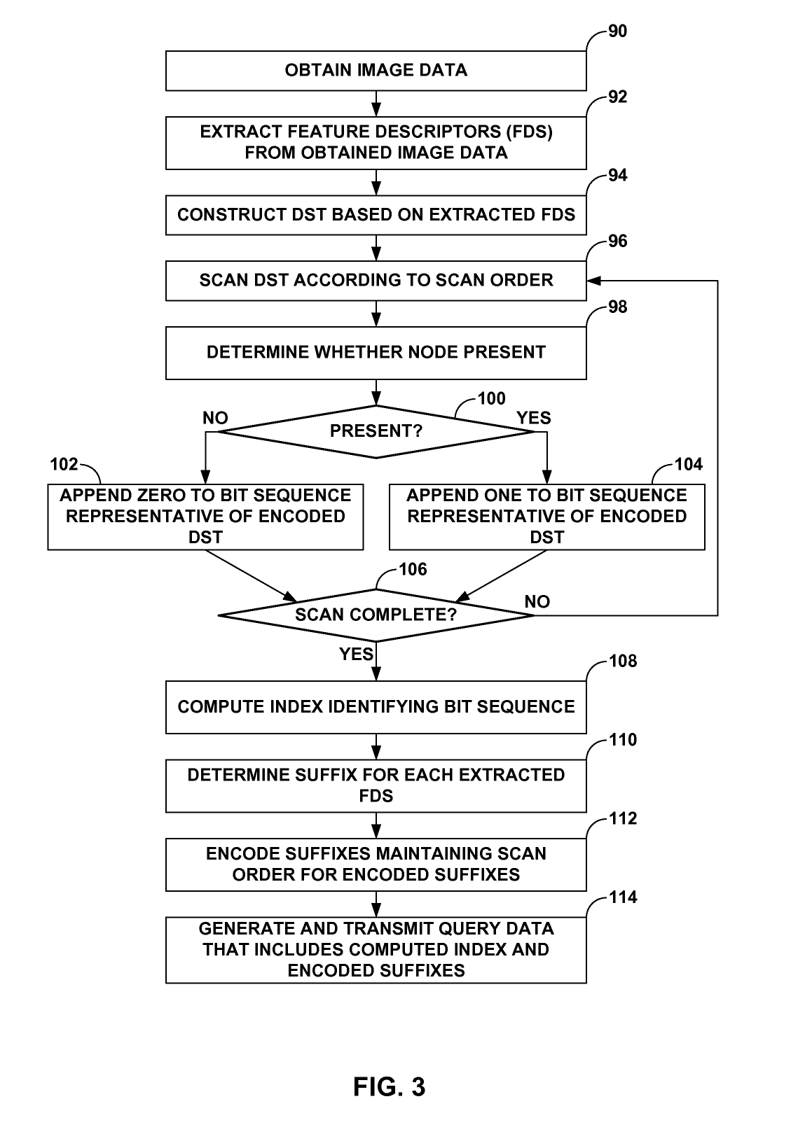

FIG. 3 is a flowchart illustrating example operation of a client device, such as client device 12 shown in the example of FIG. 1, in implementing the order-independent coding aspects of the techniques described in this disclosure. Initially, client device 12 obtains image data 26 in one of the many ways described above (90). Client device 12 may then receive input from a user requesting that a visual search be performed with respect to image data 26. In response to this input, client device 12 may invoke feature extraction unit 18.

Feature extraction unit 18 extracts feature descriptors 28, which may be abbreviated as FDS 28, from obtained image data 26 in the manner described above (92). Feature extraction unit 18 forwards feature descriptors 28 to feature compression unit 20, which is shown in more detail with respect to FIG. 2. Feature compression unit 20 first invokes DST construction unit 50 in response to receiving feature descriptors 28. DST construction unit 50, as described above, constructs DST 58 based on extracted feature descriptors 28 (94). In effect, DST construction unit 50 creates DST 58 based on prefixes of these feature descriptors 28.

Mathematically, the set of feature descriptors may be considered as a set of words {w₁, . . . , wₘ} that are binary, distinct, have the same length |wᵢ|=n, and are produced by a symmetric memoryless source (meaning that the characters ‘0’ and ‘1’ occur with the same probability p=1−p=½ regardless of their positions or order). The entropy rate of such a symmetric memoryless source is 1 bit/character, implying that conventional sequential encoding of these words will cost at least mn bits. The notation of expressing these feature descriptors 28 as words is used below to facilitate a mathematical definition of the order-independent coding techniques described in this disclosure.

To construct DST 48, DST construction unit 50 starts with a single root element that corresponds to an empty word. DST construction unit 50 then selects a first word, w₁. Depending on the value of its first character (or bit, in the binary example), DST construction unit 50 adds either a left or right branch to the root element, inserting a new element at the end of the added left or right branch. The branch may represent what is commonly referred to as “pointer” in the computer science arts. With second and subsequent words, DST construction unit 50 parses the tree starting from the root node, by following characters (or bits as noted above) in a current one of the words, until DST construction unit 50 encounters a leaf node.

At this leaf node, DST construction unit 50 determines it current depth or level (which is denoted by the variable d) and inserts either a left or right branch depending on the d+/−th most significant character of the current word. To illustrate, if the word is represented by a binary string of 11001₂ and the current depth of the leaf node is equal to two, then DST construction unit 50 analyzes the (2+1) third most significant bit of the binary string, which is zero in this instance. In this example, for a zero bit value, DST construction unit 50 adds a left branch, instantiates a new element, and directs the branch (or pointer) to this new element. DST construction unit 50 continues to construct DST 58 in this manner with respect to each one of the words (which, in this example, are assumed to be feature descriptors 28).

In constructing this DST 58, DST construction unit 50 effectively splits each word wᵢ (i=1, . . . , m) into two parts, wᵢ=pᵢsᵢ, where pᵢ are prefixes covered by paths in the tree, and sᵢ are the remaining suffixes. Overall, lengths of the prefixes and the suffixes may be expressed in accordance with the following equations (1) and (2):

$$\begin{matrix}{P}_{m} = {\sum }_{i = 1}^{m} \vert {p}_{i} \vert , and & ( 1 ) \\ {S}_{m} = {\sum }_{i = 1}^{m} \vert {s}_{i} \vert = mn - {P}_{m} . & ( 2 )\end{matrix}$$

DST construction unit 50 outputs DST 58 to prefix coding unit 52.

In response to receiving DST 58, prefix coding unit 52 scans DST 58 according to a scan order, such as the scan order defined by a pre-order tree traversal algorithm, as described above (96). In scanning DST 58 in accordance with the pre-order tree traversal algorithm, prefix coding unit 52 may scan the tree recursively. When scanning DST 58, prefix coding unit 52 traverses each element of DST 58 to determine whether the current element is present (98). If the current element is not present (“NO” 100), prefix coding unit 52 appends a zero to a bit sequence (which may be referred to as an x-sequence) representative of an encoded version of DST 58 (102). If the current element is present (“YES” 100), prefix coding unit 52 appends a one to the x-sequence representative of an encoded version of DST 58 (104). If the scan is not complete (“NO” 106), prefix coding unit 52 continues to scan DST 58 according to scan order, determine whether the current element is present and output either a one or a zero, appending this one or zero to the x-sequence until the scan is complete (96-106).

If the scan is complete (meaning that DST 58 has been scanned in its entirety and every element has been traversed), prefix coding unit 52 may compute an index uniquely identifying this x-sequence in a space of all possible x-sequences having the same length (or, in other words, generated from DSTs having the same number of elements as DST 58) as the generated x-sequence. Mathematically, it can be shown that this sequence contains 2i+1 digits and that it can server as a unique representation of a tree with i elements. Moreover, it can be shown mathematically that the total number of possible rooted binary trees with i elements is given by the Catalan number expressed by the following equation (3):

$${C}_{i} = \frac{1}{i + 1} ( \begin{matrix}2 i \\ i\end{matrix} ) , \qquad ( 3 )$$

implying that a tree can be uniquely represented by the number of bits determined in accordance with the following equation (4):

$$⌈ {log}_{2} {C}_{i} ⌉ \sim 2 i - \frac{3}{2} {log}_{2} i + O ( 1 ) [ bits ] . \qquad ( 4 )$$

That is, equation (4) illustrates that the x-sequence may not be the most efficient representation of the binary tree with i elements.

One possible coding techniques that compresses this x-sequence to achieve the rate expressed in equation (4) involves generating what may be referred to as a z-sequence based on the x-sequence. This z-sequence lists the positions of the ‘1’ characters in the x-sequence. For example, for an x-sequence of 1111100010010011000, prefix coding unit 52 may generate a z-sequence of 1, 2, 3, 4, 5, 9, 12, 15, 16. Prefix coding unit 52 may then adhere to a rule for incremental reduction of z-sequences. To express this rule mathematically, let j* represent the largest j, such that zⱼ=j. Moreover, let z*=z₁*, . . . , zᵢ₋₁* denote a new sequence that omits value z_{j*} and subtracts 2 from all subsequent values in the original sequence. This rule may then be expressed mathematically in accordance with equation (5):

$${z}_{j}^{*} = \{ \begin{matrix}{z}_{j} , & j = 1 , … , {j}^{*} - 1 \\ {z}_{j + 1} - 2 , & j \geq {j}^{*} .\end{matrix} \qquad ( 5 )$$

Prefix coding unit 52 may then recursively compute a lexicographic index 60 according to Zack's ranking scheme for this z-sequence, which may be expressed mathematically by way of the following equation (6):

$$index ( z ) = \{ \begin{matrix}1 , & if {j}^{*} = i ; \\ {a}_{{ij}^{*}} + index ( {z}^{*} ) & if {j}^{*} < i ,\end{matrix} \qquad ( 6 )$$

where aᵢⱼ represent constants that may be computed in accordance with the following equation (7):

$${a}_{ij} = \frac{j + 2}{2 i - j} ( \begin{matrix}2 i - j \\ i - j - 1\end{matrix} ) , 0 \leq j \leq i - 1. \qquad ( 7 )$$

In this manner, prefix coding unit 52 computes index 60 identifying the x-sequence (108). Prefix coding unit 52 passes this index 60 to formatting unit 56.

DST construction unit 50 also passes DST 58 to suffix coding unit 54, which determines suffixes for each of extracted feature descriptors 28 as ordered in the same order in which the prefixes were scanned (110). Suffix coding unit 54 then encodes these suffixes in the manner described above, maintaining the scan order for coded suffixes 62 (112). Suffix coding unit 54 passes coded suffixes 62 to formatting unit 56. Formatting unit 56 generates and transmits query data 30 that includes computed index 60 and coded suffixes 62 in the manner described above (114).

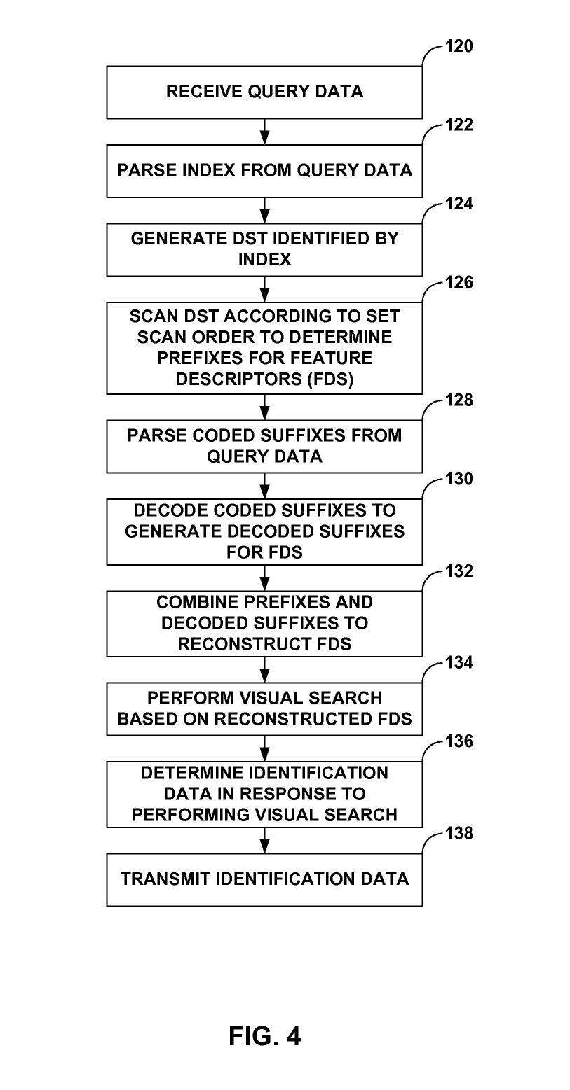

FIG. 4 is a flowchart illustrating exemplary operation of a visual search server device, such as visual search server 14 shown in the example of FIG. 1, in implementing the order-independent decoding aspects of the techniques described in this disclosure. Initially, visual search server 14 receives query data 30 (120). In response to receiving query data 30, visual search server 14 invokes feature reconstruction unit 34, which is shown in more detail in the example of FIG. 2. Referring to the example of FIG. 2, parsing unit 70 of feature reconstruction unit 34 receives query data 30 and parses index 60 from query data 30 (122). Parsing unit 70 passes index 60 to DST reconstruction unit 72.

Upon receiving index 60, DST reconstruction unit 72 reconstructs DST 58 to generate reconstructed DST 80 (124). To reconstruct DST 80 from index 60, DST reconstruction unit 72 implements the inverse of Zack's ranking scheme to convert lexicographic index 60 back into the z-sequence. DST reconstruction unit 72 then converts the z-sequence into the x-sequence described above. From this x-sequence, DST reconstruction unit 72 may generate DST 80. To illustrate, DST reconstruction unit 72 may initially generate a root element of DST 80. To determine whether this root element has a left-child element, DST reconstruction unit 72 may assess the first most significant bit of the x-sequence. If this first most significant bit is a one, DST reconstruction unit 72 may create a new element and configure the left branch or pointer to point to this new element. If the first most significant bit is a zero, DST reconstruction unit 72 determines that the root element does not have a left child element.

Assuming the first most significant bit is a one for purposes of illustration, DST reconstruction unit 72, after creating a new element and configuring the root element to reference this new element as its left child element, analyzes the second most significant bit of the x-sequence. If this second most significant bit is a one, DST reconstruction unit 72 determines that the left child element of the root element has a left child element. In response to this determination, DST reconstruction unit 72 creates or instantiates a new element and configures this left child element of the root element to reference this new element as its left child element. If this second most significant bit is a zero, however, DST reconstruction unit 72 determines that this left child element of the root element does not have a left child element.

Assuming, again, for purposes of illustration that this second most significant bit is a zero, DST reconstruction unit 72 then analyzes the third most significant bit of the x-sequence. If this third most significant bit is a one, DST reconstruction unit 72 determines that this left child element of the root element has a right child element. In response to this determination, DST reconstruction unit 72 instantiates a new element and configures the left child element of the root element to reference this new element as its right child element. If this third most significant bit is a zero, DST reconstruction unit 72 determines that this left child element of the root element does not have a right child element and, considering that it does not have either a left or right child element, represents a leaf element.

Assuming for purposes of illustration that this third most significant bit is zero, DST reconstruction unit 72 then determines whether the fourth most significant bit of the x-sequence is a one or zero. If this fourth most significant bit is a one, DST reconstruction unit 72 determines that the root element has a right child element. In response to this determination, DST reconstruction unit 72 instantiates a new element and configures the root element to reference this new element as its right child element. However, if this fourth most significant bit is a zero, DST reconstruction unit 72 determines that the root element does not have a right child element and concludes its reconstruction of DST 80 considering that none of the elements have any further child elements. DST reconstruction unit 72 may continue in this manner until all bits of the x-sequence have been analyzed.

DST reconstruction unit 72 may effectively create DST 80 according to the scan order in which the original x-sequence was generated. That is, DST reconstruction unit 72 determines whether a given element has either a right or left child element in the same manner DST construction unit 50 would determine whether a given element has a right or left child element when constructing DST 58. In the examples presented in this disclosure, DST reconstruction unit 72 may implement a pre-order tree traversal algorithm for determining whether the x-sequence indicates that a given element has either a left or right child element. DST reconstruction unit 72 passes reconstructed DST 80 to prefix scanning unit 74. Prefix scanning unit 74 scans DST 80 according to the same or pre-determined scan order as that used to generate the x-sequence (which in this example is assumed to be a pre-order tree traversal scan order) to determine prefixes 82, as described above (126). Prefix scanning unit 74 passes prefixes 82 to reconstruction unit 78.

Meanwhile, parsing unit 70 also parses coded suffixes 62 from query data 62 (128), passing these coded suffixes 62 to suffix decoding unit 76. Suffix decoding unit 76 decodes these suffixes 62 to generate suffixes 84 for feature descriptors 40 using a complementary decoding algorithm to the encoding algorithm used to encode suffixes 62 (130). Suffix decoding unit 76 then passes suffixes 84 to reconstruction unit 78. Reconstruction unit 78 combines prefixes 82 and corresponding suffixes 84 in the manner described above to reconstruct feature descriptors 28 (132). Reconstruction unit 78 outputs these reconstructed feature descriptors as feature descriptors 40.

Referring once again to the example of FIG. 1, feature reconstruction unit 36 receives feature descriptors 40 and performs a visual search based on reconstructed feature descriptors 40 (134). Feature reconstruction unit 36 determines identification data 42 in response to performing the visual search and transmits identification data 42 back to client device 12, as described above (136, 138).

FIG. 5 is a diagram illustrating an example DST 140 constructed in accordance with the order independent coding techniques described in this disclosure. A client device, such as client device 12 shown in the example of FIG. 1, may construct DST 140 for a set of sixteen words shown in the following Table 1.

TABLE 1

| Index | Word | DST path | Suffix |
|---|---|---|---|
| (i) | (wᵢ) | (prefix pᵢ) | (sᵢ) |
| 1 | 001001 | n/a | 001001 |
| 2 | 111011 | 1 | 11011 |
| 3 | 100101 | 10 | 0101 |
| 4 | 01011 | 0 | 10111 |
| 5 | 100010 | 100 | 010 |
| 6 | 101100 | 101 | 100 |
| 7 | 111100 | 11 | 1100 |
| 8 | 010101 | 01 | 0101 |
| 9 | 010010 | 010 | 010 |
| 10 | 000010 | 00 | 0010 |
| 11 | 011000 | 011 | 000 |
| 12 | 000111 | 000 | 111 |
| 13 | 011101 | 0111 | 01 |
| 14 | 000011 | 0000 | 11 |
| 15 | 001010 | 001 | 010 |
| 16 | 110011 | 110 | 011 |
| Bits: | 16 × 6 = 96 | 39 | 57 |

Given the exemplary set of words from table 1, DST construction unit 50 of feature compression unit 20 included within client device 12 (which is shown in the example of FIG. 2) may construct exemplary DST 140. While described above as not storing any of these words to the root element, in some example, such as DST 140, DST construction unit 50 may select an arbitrary word from the non-empty set of words (i.e., the first word (w₁) of the set in the example of FIG. 5) and store this to the root element, which is denoted as element 142A in the example of FIG. 5. DST construction unit 50 may then select a next word in the non-empty set of words, such as w₂, assessing the first most significant bit of this word, which is a 1 in this example. DST construction unit 50 knows to consider the first most significant bit rather than the second or any other bit in this word because DST construction unit 50 is currently at level 0 in DST 140 and adds one to the current level to determine which of the bits to assess. In any event, in response to determining that this bit is a one, DST construction unit 50 instantiates new element 142B, stores this word to element 142B and configures right child pointer 144B of root element 142A to reference new element 142B as its right child element.

DST construction unit 150 then considers the next word (w₃=100101), beginning again at root element 142A and considering the first most significant bit of this word, which in this example is a one. Based on this value of one, DST construction unit 50 then determines whether root element 142 already has a right child element. In this example, DST construction unit 50 determines that root element 142A already has a right child element 142B and traverses to that right child element, which is located at level 1 of DST 140. DST construction unit 50 then assesses the second most significant bit of the word considering that its current level is one. DST construction unit 50 determines that this second most significant bit is a zero and determines, based on this value of zero, whether element 142B has a left child element. In this example, DST construction unit 50 determines that element 142B does not current have a left child element. In response to this determination, DST construction unit 50 instantiates a new element 142C, stores this word to the new element 142C and configures left child pointer 144A of element 142B to reference element 142C as its left child element.

DST construction unit 50 may continue to construct DST 140 in the manner described above, iteratively considering each of these words until all words are stored to one of elements 142A-142P. Elements 142N, 142O, 142I, 142M, 142E, 142F and 142P represent leaf elements in that these elements do not have left and right pointers configured to reference any other element as its left and right child elements, respectively.

FIG. 6 is a diagram illustrating pre-order tree traversal of DST 140 shown in the example of FIG. 5 in order to generate a bit sequence in accordance with the order-independent techniques described in this disclosure. In the example of FIG. 6, a client device, such as client device 12 shown in the example of FIG. 1, may traverse DST 140 in order to generate a bit sequence referred to as an “x-sequence” in this disclosure. As described above, each bit of the x-sequence indicates whether a given element of DST 140 is present. According to the recursive pre-order tree traversal algorithm, prefix coding unit 52 shown in the example of FIG. 2 as being included within feature compression unit 20 of client device 12 may first assess root element 142A, but does not output a one even though this element is present because every tree has to have a root element. Next, according to this pre-order tree traversal algorithm, prefix coding unit 52 traverses left child pointer 144A of element 142A to element 142D. Upon determining that this element 142D is present in DST 140, prefix coding unit 52 appends a one to the x-sequence such that this sequence may be represented as 1₂.

Prefix coding unit 52, again according to this pre-order tree traversal algorithm, next considers element 142J, appending another one to the x-sequence indicating that this element 142J is present. According to this pre-order tree traversal algorithm, prefix coding unit 52 next traverses left child pointer 144A of element 142J to element 142L. Upon determining that element 142L is present, prefix coding unit 52 appends yet another one to the x-sequence such that this sequence now includes three bits (111₂). Prefix coding unit 52 implements the pre-order tree traversal algorithm and traverses left child pointer 144A of element 142L to element 142N and, upon determining that this element 142N is present, updates the x-sequence to 1111₂ by appending a one to the end of this sequence. Prefix coding unit 52 then attempts to traverse left child pointer 142A (which is not shown in the example of FIG. 6) of element 142N but determines that no left child element is referenced by this pointer 142A. In response to this determination, prefix coding unit 52 appends a zero to the x-sequence such that this sequence now specifies a bit sequence of 11110₂. According to this pre-order tree traversal algorithm, prefix coding unit 52 next attempts to traverse to the right child node of element 142N, but again determines that the right child pointer 144B (which is not shown in the example of FIG. 6) of this element does not reference any elements. In response to this determination, prefix coding unit 52 appends a zero to the x-sequence such that this sequence now specifies a bit sequence of 111100₂.

Prefix coding unit 52 then returns to element 142L and attempts to traverse its right child pointer 144B according to the pre-order tree traversal algorithm. Prefix coding unit 52, however, determines that this pointer does not reference any element. In response to this determination, prefix coding unit 52 appends a zero to the x-sequence such that this sequence now specifies a bit sequence of 1111000₂. Prefix coding unit 52 then returns to element 142J and traverses its right child pointer 144B to element 142O. In response to determining that element 142O is present, prefix coding unit 52 appends a one to the x-sequence such that this sequence now specifies a bit sequence of 11110001₂. Considering that both the left and right child elements of element 142O do not reference any other elements, prefix coding unit 52 appends two zeros to the x-sequence in a manner similar to that described above with respect to leaf element 142N such that this sequence now specifies a bit sequence of 1111000100₂. That is, for every leaf element, prefix coding unit 52 appends two zeros to the x-sequence to indicate that no child nodes are present for these leaf nodes.

Prefix coding unit 52 continues in this manner traversing first left sub-trees of each element and then returning to traverse each right sub-tree of each element until all of elements 142A-142P have been traversed, updating the x-sequence in the manner described above. The resulting x-sequence for this DST 140 may be expressed as a binary bit sequence of 11110001001100101001110010011000₂. The corresponding z-sequence is 1, 2, 3, 4, 8, 11, 12, 15, 17, 20, 21, 22, 25, 28, 29. Prefix coding unit 52 computes this z-sequence and then converts this z-sequence to index 60 in the manner described above.

The performance of the coding techniques may be determined mathematically. While above it was assumed that the source of the words was a symmetric binary memoryless source, the source may not always or necessarily be symmetric. If not symmetric, then equations (1) and (2) shown above may be updated so that p does not always equal ½. Instead, q=1−p. In order to determine the performance of these coding techniques, the entropy rate of a memoryless source is required, which is expressed in the following equation (8):

h(p)=−p log₂ p−(1−p)log₂(1−p). (8)

Given this entropy rate, the ideal average length of encoding a sequence of words w₁, . . . , wₘ (Lₛₑₜ*) may be determined in accordance with the following equation (9):

Lₛₑₜ*(m,n,p)=mnh(p)[bits], (9)

where n denotes the length of each word and mn is the length of the entire sequence. Allowing for arbitrary reordering of the decoded words in the non-empty set {w₁, . . . , wₘ}, the ideal average length of such a code may be represented by the following equation (10):

Lₛₑₜ*(m,n,p)=mnh(p)−log₂ m![bits]. (10)

It is assumed that the word length n will be sufficiently large such that, in the asymptotic sense (with both m, n going to infinity), the following expression (11) holds true:

$$\frac{n}{log m} > \frac{1}{h ( p )} . \qquad ( 11 )$$

Now, given a specific algorithm ξ for producing codes with average lengths L_{ξ}(m, n, p), the average redundancy rate for coding of sets may be expressed in accordance with the following equation (12):

$$\begin{matrix}{R}_{ξ} ( m , n , p ) = \frac{1}{mn} [ {L}_{ξ} ( m , n , p ) - {L}_{set}^{*} ( m , n , p ) ] \\ = \frac{1}{mn} {L}_{ξ} ( m , n , p ) - [ h ( p ) - \frac{1}{mn} {log}_{2} m ! ] .\end{matrix} \qquad ( 12 )$$

This definition of average redundancy rate is similar to the one used in sequential source doing, except that in this instance, the ideal rate is not longer the entropy h(p) but rather

$$h ( p ) - \frac{1}{mn} {log}_{2} m ! .$$

Thus, the average redundancy rate of DST-based encoding of a set of m binary words of length n (such as feature descriptors 28) in a memoryless model satisfies (with m, n going to infinity, n/log₂ m>1/h(p)) may be expressed as the following equation (13):

$${R}_{DST} ( m , m , p ) = \frac{1}{n} [ A ( p ) + δ ( m ) + O ( \frac{log m}{m} ) ] , \qquad ( 13 )$$

A(p) is a constant whose value may be expressed according to the following question (14):

$$A ( p ) = 2 - \frac{γ - 2}{ln 2} - \frac{{h}_{2} ( p )}{2 h ( p )} + α ( p ) , \qquad ( 14 )$$

where γ=0.577 . . . is the Euler constant and h(p) is the entropy of the source. Both of h₂(p) and a(p) may be expressed in accordance with the following equations (15) and (16):

h₂(p)=p log₂² p+q log₂² q,and (15)

$$a ( p ) = - {\sum }_{k = 1}^{∞} \frac{{p}^{k + 1} {log}_{2} p + {q}^{k + 1} {log}_{2} q}{1 - {p}^{k + 1} - {q}^{k + 1}} . \qquad ( 16 )$$

The function δ(m) is a zero mean, oscillating function of a small magnitude.

The code generated in accordance with the techniques described in this disclosure has two parts: 1) an encoded tree, occupying at most [log₂ Cₘ]≦log₂ Cₘ+1 bits, and 2) an encoded sequence of suffixes. Assuming that block Shannon codes are used to encode the suffixes, the generated code has an expected length that may be mathematically expressed by the following equation (17):

L_{suff}(Sₘ,p)≦Sₘh(p)+1, (17)

where Sₘ=m n−Dₙ denotes the total length of all suffixes and h(p) is the entropy of the source. Since L_{suff} is bounded by a linear function, Sₘ, it can further be shown that the average length of a code considering all possible suffix lengths can be expressed mathematically by the following equation (18):

$${\sum }_{s} Pr ( {S}_{m} = s ) {L}_{suff} ( s , p ) \leq {\overline{S}}_{m} h ( p ) + 1 , \qquad ( 18 )$$

where S̅ₘ=ESₘ is the expected length of suffixes in our set. In turn, S̅ₘ may be expressed as S̅ₘ=mn− P̅ₘ, where P̅ₘ=EPₘ is the expended path length in the DST tree.

Next, the result for the so-called average depth of the DST may be computed according to the following equation (19):

$$\frac{1}{m} {\overline{P}}_{m} = \frac{1}{h ( p )} [ {log}_{2} m + \frac{{h}_{2} ( p )}{2 h ( p )} + \frac{γ - 1}{ln 2} - α + {δ}_{1} ( m ) + O ( \frac{log m}{m} ) ] . \qquad ( 19 )$$

The expected code lengths may then be computed in accordance with the following equation (20):

$$\begin{matrix}{L}_{DST} ( m , n , p ) \leq {log}_{2} {C}_{m} + {\overline{S}}_{m} h ( p ) + 2 \\ = mnh ( p ) + {log}_{2} {C}_{m} - {\overline{P}}_{m} h ( p ) + 2 \\ = … \\ = mnh ( p ) - m {log}_{2} m + \\ m [ 2 - \frac{γ - 1}{ln 2} - \frac{{h}_{2} ( p )}{2 h ( p )} + α ( p ) - δ ( m ) ] + \\ O ( log m ) .\end{matrix} \qquad ( 20 )$$

By combining equation (20) this with asymptotic decomposition, the following equation (21) may be derived:

$${log}_{2} m != m {log}_{2} m - \frac{1}{ln 2} m + O ( log m ) , \qquad ( 21 )$$

which expresses the redundancy term asserted above with respect to equation (13).

As evident from the above performance analysis, the average redundancy rate of the proposed scheme decays as

$$O ( \frac{1}{n} )$$

as word length n increases. From this, it can be understood that the coding techniques described in this disclosure scales well with respect to word length n. Moreover, this redundancy rate is not growing with the number of words in our set m. Rather than introduce log₂ m! overhead using sequential or order-dependent encoding techniques, it can be observed that the coding techniques described in this disclosure provide a logarithmic

$$( \frac{{log}_{2} m !}{mn} \sim \frac{{log}_{2} m}{n} )$$

increase of redundancy rate with m. The redundancy rate of the codign techniques described in this disclosure stays almost constant (with respect to m), defined by the leading factor A(p) and a small-magnitude oscillating function δ(m). Overall, this scheme may suggest it is possible to design a code for a set of words that delivery near, if not, optimal performance.

In one or more examples, the functions described may be implemented in a control unit, which may comprise hardware, software, firmware, or any combination thereof. If implemented in software, the functions may be stored on or transmitted over as one or more instructions or code on a computer-readable medium. Computer-readable media may include computer data storage media or communication media including any medium that facilitates transfer of a computer program from one place to another. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage, or other magnetic storage devices, flash memory, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The code may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various embodiments of the invention have been described. These and other embodiments are within the scope of the following claims.

1. A method for coding an unordered set of two or more words, the method comprising:
constructing a digital search tree data structure with a compression unit to store the two or more words, wherein the digital search tree includes a node to store each of the two or more words, wherein a prefix of each of the two or more words identifies a path from a root to one of the nodes that stores the corresponding one of the two or more words, and wherein a suffix of each of the words is stored in the node identified by the corresponding prefix of the two or more words;
traversing the digital search tree data structure with the compression unit to retrieve each of the suffixes of the words of the two or more words in accordance with a defined order;
encoding the suffixes with the compression unit in the defined order in which the suffixes were retrieved from the digital search tree data structure;
encoding the digital search tree data structure with the compression unit in a manner that encodes an arrangement of the nodes in the digital search tree data structure without encoding the placement of the nodes of the digital search tree data structure with respect to one another to generate an encoded digital search tree data structure;
transmitting the encoded digital search structure with an interface; and
transmitting the encoded suffixes with the interface in the defined order in which the suffixes were retrieved from the digital search tree data structure.

2. The method of claim 1,
wherein the two or more words comprise two or more image feature descriptors,
wherein the method further comprises extracting the two or more feature descriptors from an image, and
wherein transmitting the encoded digital search tree data structure and the encoded suffixes comprises transmitting the encoded digital search tree data structure and the encoded suffixes to a visual search server so as to initiate a visual search.

3. The method of claim 2, wherein the feature descriptors each comprise a set of histograms of gradients captured using a patch around one or more key-points.

4. The method of claim 1, wherein encoding the digital search tree data structure comprises:
recursively traversing the digital search tree data structure to determine whether each of the nodes of the digital search tree data structure is included within either a left sub-tree or a right sub-tree depending from another one of the nodes; and
encoding the digital search tree data structure based on the determination.

5. The method of claim 1, wherein encoding the digital search tree data structure comprises:
recursively traversing the digital search tree data structure according to the defined order to determine whether each of the nodes of the digital search tree data structure is included within either a left sub-tree or a right sub-tree depending from another one of the nodes;
in response to determining that one of the nodes is included within the left sub-tree depending from another one of the nodes, appending a one to an end of a binary bit sequence (an x-sequence); and
in response to determining that the one of the nodes is included within the right sub-tree depending from another one of the nodes, appending a zero to the end of the binary bit sequence (the x-sequence).

6. The method of claim 5, wherein encoding the digital search tree data structure further comprises outputting the x-sequence as the encoded digital search tree data structure.

7. The method of claim 5, wherein encoding the digital search tree data structure further comprising:
converting the x-sequence into a z-sequence, wherein the z-sequence comprises a list of identifiers, each of the identifiers identifying a position of a different bit value in the x-sequence that is set to a value of one;
determining a lexicographic index that identifies the z-sequence with respect to all possible z-sequences that could be converted from any x-sequence having a same length as the x-sequence from which the z-sequence was converted; and
outputting the lexicographic index as the encoded digital search tree data structure.

8. The method of claim 7, wherein determining the lexicographic index comprises determining the lexicographic index in accordance with Zack's ranking scheme.

9. The method of claim 1, wherein the defined order comprises an order defined by pre-order tree traversal algorithm.

10. The method of claim 1, wherein encoding the suffixes comprises encoding the suffixes in the defined order in which the suffixes were retrieved from the digital search tree data structure using one of Hoffman codes, Shannon codes or arithmetic codes.

11. An apparatus for coding two or more words in an order-independent manner, the apparatus comprising:
means for constructing a digital search tree data structure with a compression unit to store the two or more words, wherein the digital search tree includes a node to store each of the two or more words, wherein a prefix of each of the two or more words identifies a path from a root to one of the nodes that stores the corresponding one of the two or more words, and wherein a suffix of each of the words is stored in the node identified by the corresponding prefix of the two or more words;
means for traversing the digital search tree data structure with the compression unit to retrieve each of the suffixes of the words of the two or more words in accordance with a defined order;
means for encoding the suffixes with the compression unit in the defined order in which the suffixes were retrieved from the digital search tree data structure;
means for encoding the digital search tree data structure with the compression unit in a manner that encodes an arrangement of the nodes in the digital search tree data structure without encoding the placement of the nodes of the digital search tree data structure with respect to one another to generate an encoded digital search tree data structure;
means for transmitting the encoded digital search structure; and
means for transmitting the encoded suffixes in the defined order in which the suffixes were retrieved from the digital search tree data structure.

12. The apparatus of claim 11,
wherein the two or more words comprise two or more image feature descriptors,
wherein the apparatus further comprises means for extracting the two or more feature descriptors from an image, and
wherein the means for transmitting the encoded digital search tree data structure and the means for transmitting the encoded suffixes comprises means for transmitting the encoded digital search tree data structure and means for transmitting the encoded suffixes to a visual search server so as to initiate a visual search.

13. The apparatus of claim 12, wherein the feature descriptors each comprise a set of histograms of gradients captured using a patch around one or more key-points.

14. The apparatus of claim 11, wherein the means for encoding the digital search tree data structure comprises:
means for recursively traversing the digital search tree data structure to determine whether each of the nodes of the digital search tree data structure is included within either a left sub-tree or a right sub-tree depending from another one of the nodes; and
means for encoding the digital search tree data structure based on the determination.

15. The apparatus of claim 11, wherein the means for encoding the digital search tree data structure comprises:
means for recursively traversing the digital search tree data structure according to the defined order to determine whether each of the nodes of the digital search tree data structure is included within either a left sub-tree or a right sub-tree depending from another one of the nodes;
in response to determining that one of the nodes is included within the left sub-tree depending from another one of the nodes, means for appending a one to an end of a binary bit sequence (an x-sequence); and
in response to determining that the one of the nodes is included within the right sub-tree depending from another one of the nodes, means for appending a zero to the end of the binary bit sequence (the x-sequence).

16. The apparatus of claim 15, wherein the means for encoding the digital search tree data structure further comprises means for outputting the x-sequence as the encoded digital search tree data structure.

17. The apparatus of claim 15, wherein the means for encoding the digital search tree data structure further comprising:
means for converting the x-sequence into a z-sequence, wherein the z-sequence comprises a list of identifiers, each of the identifiers identifying a position of a different bit value in the x-sequence that is set to a value of one;
means for determining a lexicographic index that identifies the z-sequence with respect to all possible z-sequences that could be converted from any x-sequence having a same length as the x-sequence from which the z-sequence was converted; and
means for outputting the lexicographic index as the encoded digital search tree data structure.

18. The apparatus of claim 17, wherein the means for determining the lexicographic index comprises means for determining the lexicographic index in accordance with Zack's ranking scheme.

19. The apparatus of claim 11, wherein the defined order comprises an order defined by pre-order tree traversal algorithm.

20. The apparatus of claim 11, wherein the means for encoding the suffixes comprises means for encoding the suffixes in the defined order in which the suffixes were retrieved from the digital search tree data structure using one of Hoffman codes, Shannon codes or arithmetic codes.

21. An apparatus for coding two or more words in an order-independent manner, the apparatus comprising:
a compression unit that constructs a digital search tree data structure to store the two or more words, wherein the digital search tree includes a node to store each of the two or more words, wherein a prefix of each of the two or more words identifies a path from a root to one of the nodes that stores the corresponding one of the two or more words, and wherein a suffix of each of the words is stored in the node identified by the corresponding prefix of the two or more words;
wherein the compression unit further traverses the digital search tree data structure to retrieve each of the suffixes of the words of the two or more words in accordance with a defined order, encodes the suffixes in the defined order in which the suffixes were retrieved from the digital search tree data structure, encodes the digital search tree data structure in a manner that encodes an arrangement of the nodes in the digital search tree data structure without encoding the placement of the nodes of the digital search tree data structure with respect to one another to generate an encoded digital search tree data structure; and
an interface that transmits the encoded digital search structure and the encoded suffixes in the defined order in which the suffixes were retrieved from the digital search tree data structure.

22. The apparatus of claim 21,
wherein the two or more words comprise two or more image feature descriptors,
wherein the apparatus further comprises a feature extraction unit that extracts the two or more feature descriptors from an image, and
wherein the interface transmits the encoded digital search tree data structure and the encoded suffixes comprises transmitting the encoded digital search tree data structure and the encoded suffixes to a visual search server so as to initiate a visual search.

23. The apparatus of claim 22, wherein the feature descriptors each comprise a set of histograms of gradients captured using a patch around one or more key-points.

24. The apparatus of claim 21, wherein the compression unit further recursively traverses the digital search tree data structure to determine whether each of the nodes of the digital search tree data structure is included within either a left sub-tree or a right sub-tree depending from another one of the nodes and encodes the digital search tree data structure based on the determination.

25. The apparatus of claim 21, wherein the compression unit further recursively traverses the digital search tree data structure according to the defined order to determine whether each of the nodes of the digital search tree data structure is included within either a left sub-tree or a right sub-tree depending from another one of the nodes, in response to determining that one of the nodes is included within the left sub-tree depending from another one of the nodes, appends a one to an end of a binary bit sequence (an x-sequence) and, in response to determining that the one of the nodes is included within the right sub-tree depending from another one of the nodes, appends a zero to the end of the binary bit sequence (the x-sequence).

26. The apparatus of claim 25, wherein the compression unit outputs the x-sequence as the encoded digital search tree data structure.

27. The apparatus of claim 25, wherein the compression unit further converts the x-sequence into a z-sequence, wherein the z-sequence comprises a list of identifiers, each of the identifiers identifying a position of a different bit value in the x-sequence that is set to a value of one, determines a lexicographic index that identifies the z-sequence with respect to all possible z-sequences that could be converted from any x-sequence having a same length as the x-sequence from which the z-sequence was converted and outputs the lexicographic index as the encoded digital search tree data structure.

28. The apparatus of claim 27, wherein the compression unit determines the lexicographic index in accordance with Zack's ranking scheme.

29. The apparatus of claim 21, wherein the defined order comprises an order defined by pre-order tree traversal algorithm.

30. The apparatus of claim 21, wherein the compression unit encodes the suffixes in the defined order in which the suffixes were retrieved from the digital search tree data structure using one of Hoffman codes, Shannon codes or arithmetic codes.

31. A non-transitory computer-readable medium comprising instructions for coding two or more words in an order-independent manner that, when executed, cause one or more processors to:
construct a digital search tree data structure with a compression unit to store the two or more words, wherein the digital search tree includes a node to store each of the two or more words, wherein a prefix of each of the two or more words identifies a path from a root to one of the nodes that stores the corresponding one of the two or more words, and wherein a suffix of each of the words is stored in the node identified by the corresponding prefix of the two or more words;
traverse the digital search tree data structure with the compression unit to retrieve each of the suffixes of the words of the two or more words in accordance with a defined order;
encode the suffixes with the compression unit in the defined order in which the suffixes were retrieved from the digital search tree data structure;
encode the digital search tree data structure with the compression unit in a manner that encodes an arrangement of the nodes in the digital search tree data structure without encoding the placement of the nodes of the digital search tree data structure with respect to one another to generate an encoded digital search tree data structure;
transmit the encoded digital search structure with an interface; and
transmit the encoded suffixes with the interface in the defined order in which the suffixes were retrieved from the digital search tree data structure.

32. A method for decoding two or more coded words expressed as an index and corresponding one or more coded suffixes of the two or more coded words ordered in accordance with a defined order, the method comprising:
converting the index into a bit sequence;
constructing a digital search tree data structure based on the bit sequence, wherein the digital search tree data structure comprises a node for storing each of one or more decoded words corresponding to the coded words;
traversing the digital search tree data structure in accordance with the defined order to generate prefixes for the decoded words that maintain the defined order;
decoding the coded suffixes to generate decoded suffixes that maintain the defined order; and
generating one or more decoded words corresponding to the coded words based on the decoded suffixes and the output prefixes.

33. The method of claim 32,
wherein the two or more coded words comprise two or more coded feature descriptors,
wherein the two or more decoded words comprise two or more decoded feature descriptors, and
wherein the method further comprises:
performing a visual search based on the decoded feature descriptors to determine identification data identifying two or more features described by the two or more decoded feature descriptors; and
transmitting the identification data in response to the two or more coded feature descriptors.

34. The method of claim 33, wherein the decoded feature descriptors each comprise a set of histograms of gradients captured using a patch around one or more key-points.

35. The method of claim 32,
wherein the index comprises a lexicographic index, and
wherein converting the index into a bit sequence comprises:
performing an inverse of a Zack's ranking scheme to convert the lexicographic index into a z-sequence that identifies relative positions of bits having a value of one in a binary bit sequence (x-sequence);
converting the z-sequence to the x-sequence, and
wherein constructing a digital search tree data structure based on the bit sequence comprises constructing the digital search tree data structure based on the x-sequence.

36. The method of claim 35, wherein constructing the digital search tree data structure based on the x-sequence comprises:
analyzing each bit of the x-sequence from most significant bit to least significant bit to determine whether each of the bits has a value of one or zero; and
in response to determining that one of the bits has a value of one, instantiating a new node and configuring one of the nodes of the digital search tree data structure to reference the new node as either a left child node or a right child node based on a tree traversal algorithm.

37. The method of claim 36, wherein the tree traversal algorithm comprises a pre-order tree traversal algorithm.

38. An apparatus for decoding two or more coded words expressed as an index and corresponding two or more coded suffixes of the two or more coded words ordered in accordance with a defined order, the apparatus comprising:
means for converting the index into a bit sequence;
means for constructing a digital search tree data structure based on the bit sequence, wherein the digital search tree data structure comprises a node for storing each of two or more decoded words corresponding to the coded words;
means for traversing the digital search tree data structure in accordance with the defined order to generate prefixes for the decoded words that maintain the defined order;
means for decoding the coded suffixes to generate decoded suffixes that maintain the defined order; and
means for generating two or more decoded words corresponding to the coded words based on the decoded suffixes and the output prefixes.

39. The apparatus of claim 38,
wherein the two or more coded words comprise two or more coded feature descriptors,
wherein the two or more decoded words comprise two or more decoded feature descriptors, and
wherein the apparatus further comprises:
means for performing a visual search based on the decoded feature descriptors to determine identification data identifying two or more features described by the two or more decoded feature descriptors; and
means for transmitting the identification data in response to the two or more coded feature descriptors.

40. The apparatus of claim 39, wherein the decoded feature descriptors each comprise a set of histograms of gradients captured using a patch around one or more key-points.

41. The apparatus of claim 38,
wherein the index comprises a lexicographic index, and
wherein the means for converting the index into a bit sequence comprises:
means for performing an inverse of a Zack's ranking scheme to convert the lexicographic index into a z-sequence that identifies relative positions of bits having a value of one in a binary bit sequence (x-sequence);
means for converting the z-sequence to the x-sequence, and
wherein the means for constructing a digital search tree data structure based on the bit sequence comprises means for constructing the digital search tree data structure based on the x-sequence.

42. The apparatus of claim 41, wherein the means for constructing the digital search tree data structure based on the x-sequence comprises:
means for analyzing each bit of the x-sequence from most significant bit to least significant bit to determine whether each of the bits has a value of one or zero;
in response to determining that one of the bits has a value of one, means for instantiating a new node; and
means for configuring one of the nodes of the digital search tree data structure to reference the new node as either a left child node or a right child node based on a tree traversal algorithm.

43. The apparatus of claim 42, wherein the tree traversal algorithm comprises a pre-order tree traversal algorithm.

44. An apparatus for decoding two or more coded words expressed as an index and corresponding two or more coded suffixes of the two or more coded words ordered in accordance with a defined order, the apparatus comprising:
a reconstruction unit that converts the index into a bit sequence, constructs a digital search tree data structure based on the bit sequence, wherein the digital search tree data structure comprises a node for storing each of two or more decoded words corresponding to the coded words, traverses the digital search tree data structure in accordance with the defined order to generate prefixes for the decoded words that maintain the defined order, decodes the coded suffixes to generate decoded suffixes that maintain the defined order and generates two or more decoded words corresponding to the coded words based on the decoded suffixes and the output prefixes.

45. The apparatus of claim 44,
wherein the two or more coded words comprise two or more coded feature descriptors,
wherein the two or more decoded words comprise two or more decoded feature descriptors, and
wherein the reconstruction unit further performs a visual search based on the decoded feature descriptors to determine identification data identifying two or more features described by the two or more decoded feature descriptors and transmits the identification data in response to the two or more coded feature descriptors.

46. The apparatus of claim 45, wherein the decoded feature descriptors each comprise a set of histograms of gradients captured using a patch around one or more key-points.

47. The apparatus of claim 44,
wherein the index comprises a lexicographic index, and
wherein the reconstruction unit further performs an inverse of a Zack's ranking scheme to convert the lexicographic index into a z-sequence that identifies relative positions of bits having a value of one in a binary bit sequence (x-sequence), converts the z-sequence to the x-sequence and constructs the digital search tree data structure based on the x-sequence.

48. The apparatus of claim 47, wherein the reconstruction unit further analyzes each bit of the x-sequence from most significant bit to least significant bit to determine whether each of the bits has a value of one or zero and, in response to determining that one of the bits has a value of one, instantiates a new node and configuring one of the nodes of the digital search tree data structure to reference the new node as either a left child node or a right child node based on a tree traversal algorithm.

49. The apparatus of claim 48, wherein the tree traversal algorithm comprises a pre-order tree traversal algorithm.

50. A non-transitory computer-readable medium comprising instructions for decoding two or more coded words expressed as an index and corresponding two or more coded suffixes of the two or more coded words ordered in accordance with a defined order, wherein the instruction, when executed, cause two or more processors to:
convert the index into a bit sequence;
construct a digital search tree data structure based on the bit sequence, wherein the digital search tree data structure comprises a node for storing each of two or more decoded words corresponding to the coded words;
traverse the digital search tree data structure in accordance with the defined order to generate prefixes for the decoded words that maintain the defined order;
decode the coded suffixes to generate decoded suffixes that maintain the defined order; and
generate two or more decoded words corresponding to the coded words based on the decoded suffixes and the output prefixes.
